(19) United States
(12) Patent Application Publication
(10) Pub. No.: US 2006/0277829 A1
(43) Pub. Date: Dec. 14, 2006

(54) Partition

(76) Inventor: Zoltan Anton Kiefer, Mainz (DE)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/554,828

(22) PCT Filed: Apr. 26, 2004
(86) PCT No.: PCT/EP04/04376

§ 371 Date: Jan. 6, 2006

(30) Foreign Application Priority Data
Apr. 29, 2003 (DE) 103 19 170.4

(51) Int. Cl. E06B 3/34

(52) U.S. Cl. 49/40; 49/409

(57) ABSTRACT

The invention relates to a partition (10), in particular for a shower comprising at least one sliding door (11) and at least one partition element (12) adjacent thereto. Said invention is characterised in that, at least one surface of the sliding door(s) (11) in the closed position thereof terminates on the same plane that the surface of said partition element(s) (12).

The invention relates to a partition, in particular for a shower stall, with at least one sliding door and at least one partition element adjacent thereto.

In general, partitions with sliding doors are known from the state of the art. Sliding doors are always used in situations in which for reasons of space the use of a door pivoted on a hinge is not possible. Sliding doors have the disadvantage, however, that in the closed state they exhibit an offset to the surface surrounding them which is to be closed off. This offset has a disruptive effect on the design, in particular in situations in which high demands are placed on the design and cleaning is rendered difficult in the transition area from the sliding door to the surface surrounding the sliding door.

The object of the invention is therefore to improve a partition of the type described in the preamble in such a way that the surface of the sliding door is easy to clean even in the transition area from the sliding door to the surrounding surface, and the design is not disrupted by the sliding door being offset.

The invention resolves this object described by means of a partition of the type referred to in the preamble, which is characterised in that at least one surface side of the minimum of one sliding door in the closed state closes flush with a surface side of the minimum of one partition element. As a result of the flush closure of the minimum of one sliding door with minimum of one adjacent partition element, the offset which was previously found disruptive is done away with. Accordingly, both the sliding door as well as the minimum of one partition element adjacent to it can be cleaned with no effort at all. As well as this, the design of the entire partition is enhanced.

In order for the minimum of one sliding door to open easily, in order to be opened it is displaced out of a first plane in which it is located in the closed state into a second plane for opening.

To the purpose, the minimum of one sliding door is guided in rails at two opposed ends. The sliding door can be slid particularly easily and with low wear if it is guided in the rails by rollers. The rollers in this situation, in a preferred embodiment, are arranged on a slide or carriage.

In a further embodiment of the invention, the slides or carriages exhibit one element on the rail side and one on the door side. Accordingly, the slide or carriage is secured both to the minimum of one sliding door and also connected to the rails.

To advantage, the element on the rail side and on the door side are connected to one another by means of a connecting element.

In order for the minimum of one sliding door to be displaced out of the first plane into the second plane, the rail-side element and the door-side element are connected to the connection element by way of a joint.

It is particularly simple in terms of design, and therefore favourable in terms of manufacture, if the rail-side element, the door-side element, and the connection element are designed as link plates.

With the sliding door closed, the rail-side element can be in contact on the one side of the connection element, and the door-side element on the opposite side of the connection element. As a result, when the sliding door is closed the slide or carriage occupies only a little space, and therefore allows the sliding door in the closed position to be positioned in the first plane.

To advantage, the rail-side and the door-side element of the carriage or slide are subjected to preliminary spring tension into the opening position when the sliding door is closed. This makes the sliding door easier to open.

To the purpose, magnets are located in the rail-side element and the connection element and/or the door-side element and the connection element, which, when the sliding door is closed, lie above another, and therefore reliably hold the sliding door in its closed position.

In one preferred embodiment, a fixed-position wedge is located in each case on at least one of the rails, which, when the sliding door is closed, is accommodated in an appropriately designed cut-out or aperture in the connection element. When it is intended that the closed sliding door should be opened, it is slid effortlessly in the corresponding opening direction along the rails, whereby the inclined face of the wedge slides along the correspondingly inclined face of the aperture. As a result, the magnets located on one another are separated and the magnetic closure is thereby opened effortlessly.

In order for the sliding door to be opened as easily as possible, the wedge can be adjusted along the rails for the purpose of optimum positioning.

In order to be able to install the door-side element easily with the minimum of one sliding door, bolts can be arranged on the door-side element which engage in corresponding apertures in the minimum of one sliding door.

If the door-side element with the minimum of one sliding door is adhesively bonded, for example by means of an adhesive film, the door-side element can be connected to the minimum of one sliding door very simply, rapidly, and reliably.

To the purpose, a setting screw can be screwed into the door-side element in order to adjust the door-side element to the rail.

In order for the minimum of one sliding door to be moved along the rails after it has been displaced out of the first plane into the second plane, cut-outs or apertures can be provided in at least one partition element adjacent to the minimum of one sliding door. Accordingly, the risk of collision between the connection element of the slide or carriage with the minimum of one adjacent partition element is excluded. These apertures can be closed with closure parts, for example a brush element or the like, which are withdrawn when the sliding door is moved.

An embodiment is described in greater detail hereinafter on the basis of the appended drawing.

The Figures show specifically:

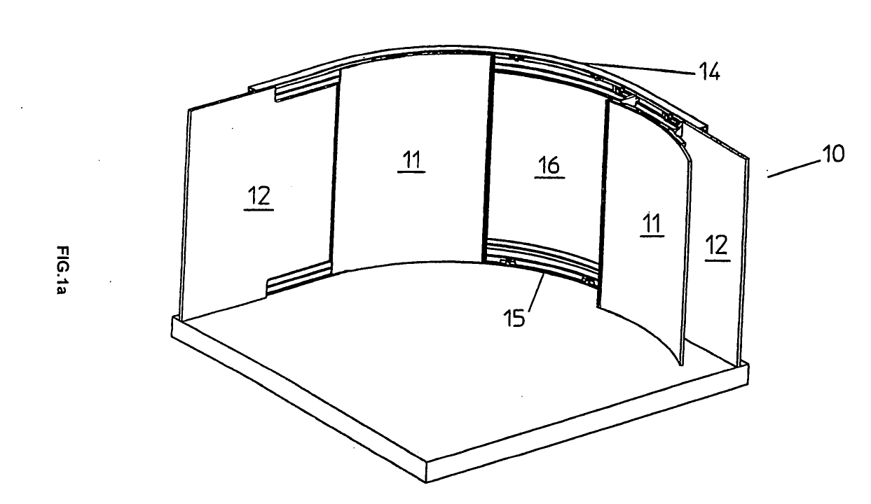

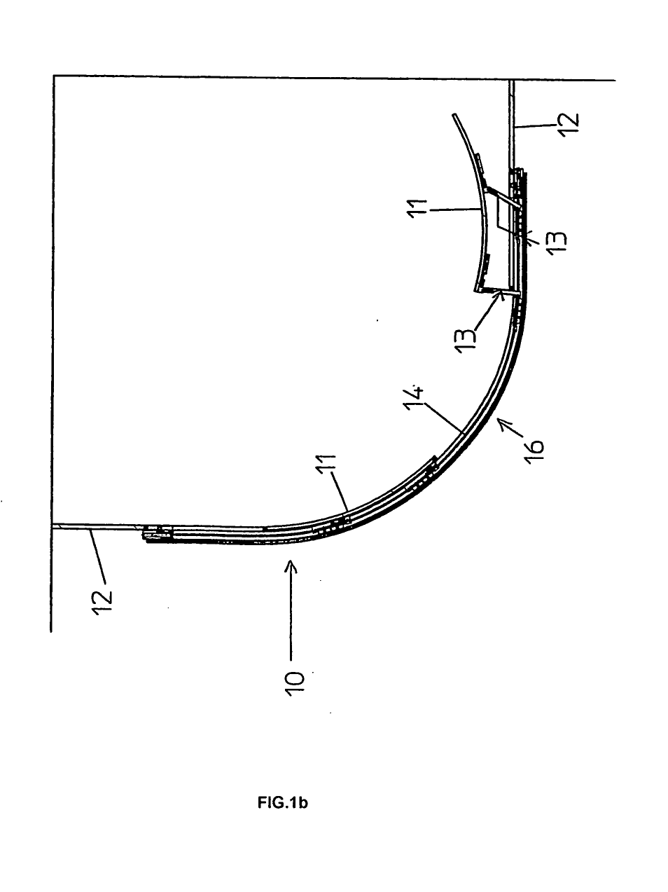

FIG. 1a a perspective plan view of a partition;

FIG. 1b a view from above of the partition from FIG. 1a;

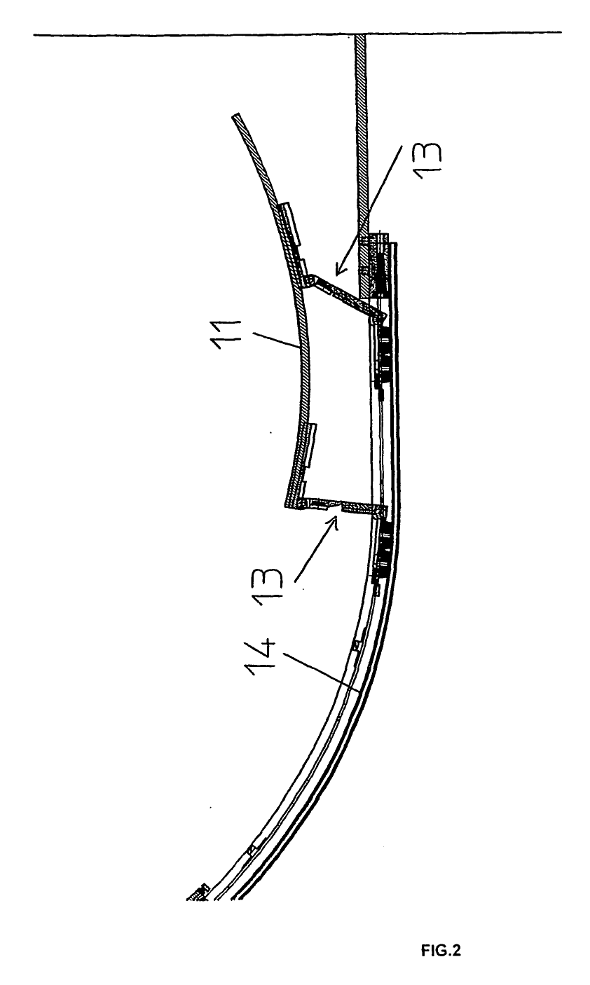

FIG. 2 a detailed view of the partition from FIG. 1b;

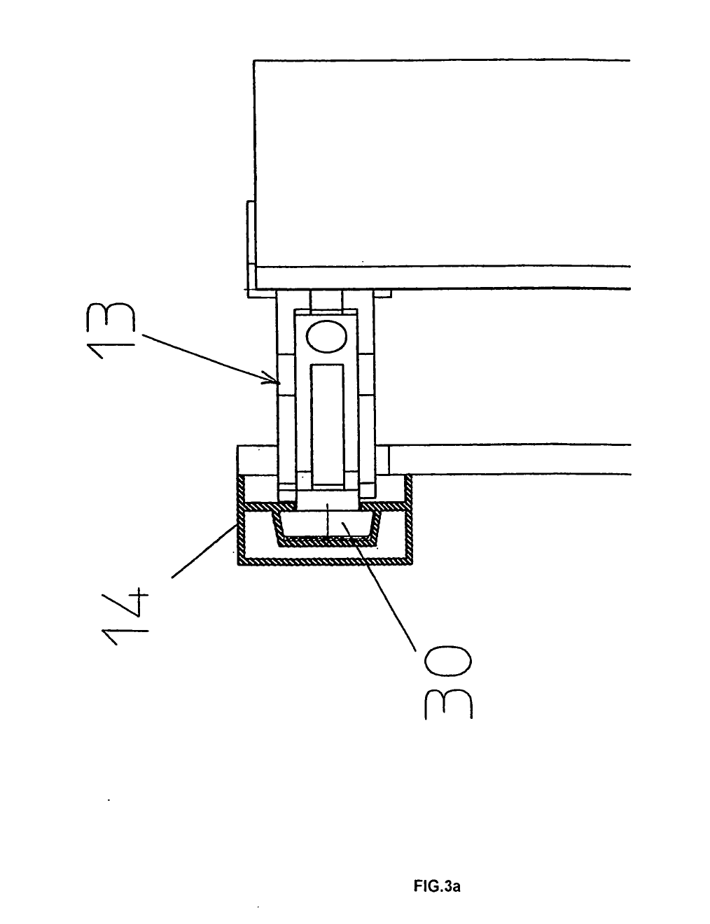

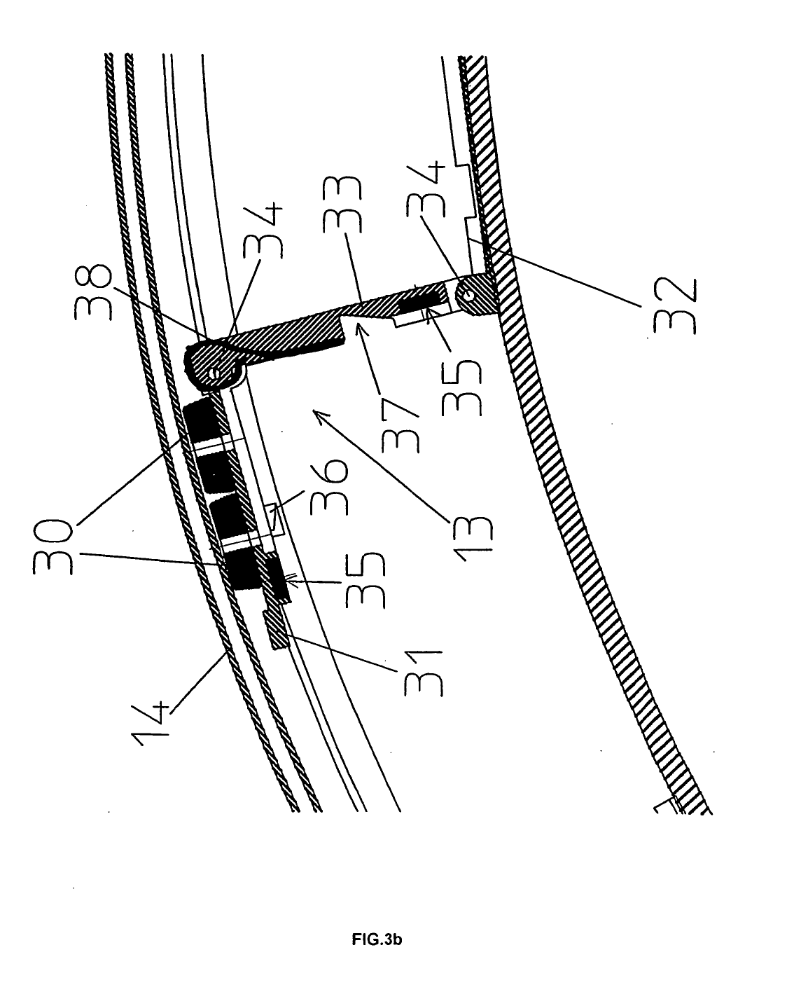

FIG. 3a a front view of a slide or carriage;

FIG. 3b a view from above of the slide or carriage from FIG. 2a;

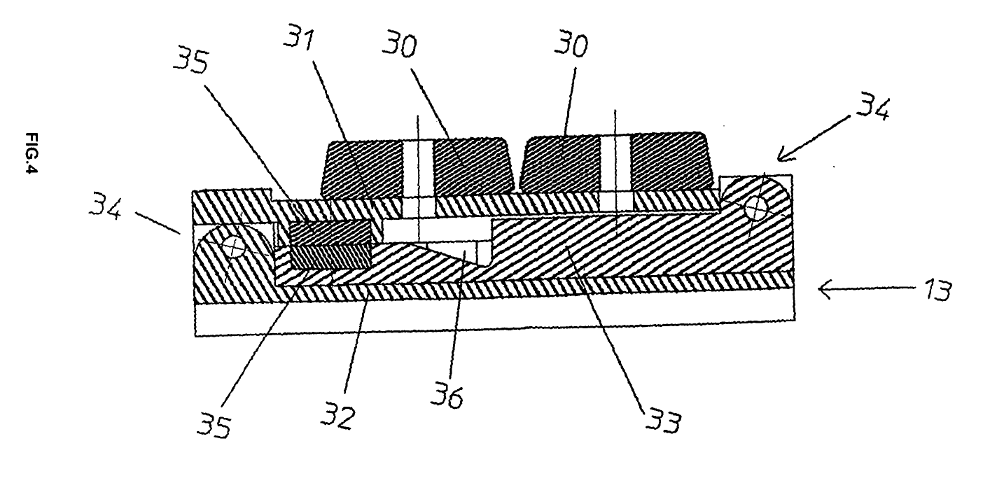

FIG. 4 a detailed view from above of the slide or carriage with the sliding door closed;

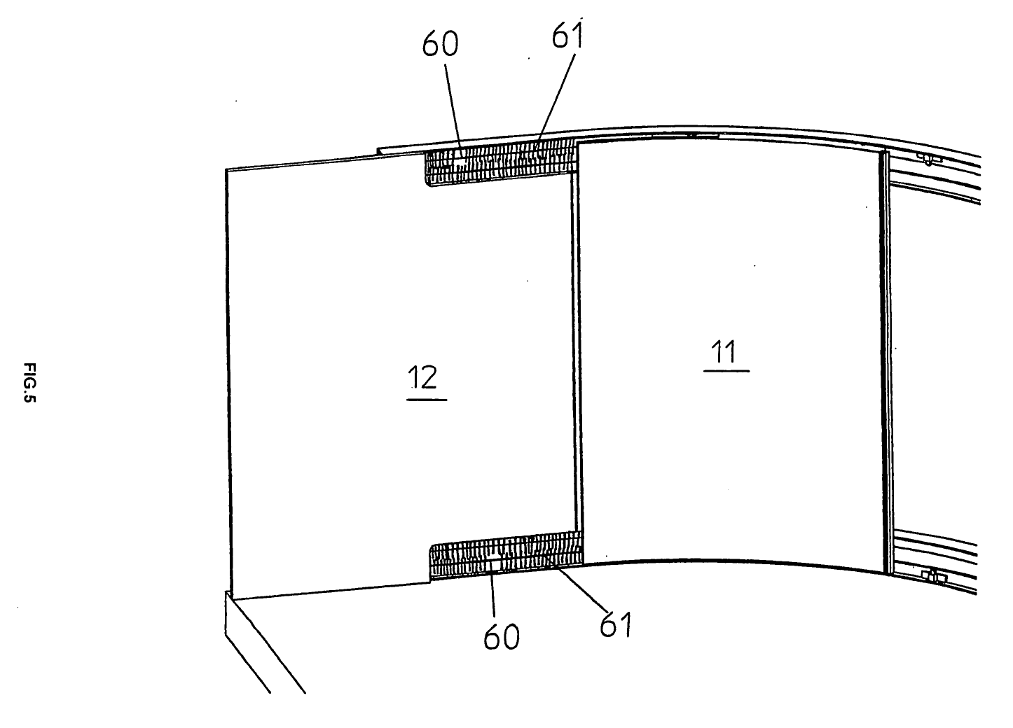

FIG. 5 a perspective front view of the closed sliding door and a partition element adjacent thereto;

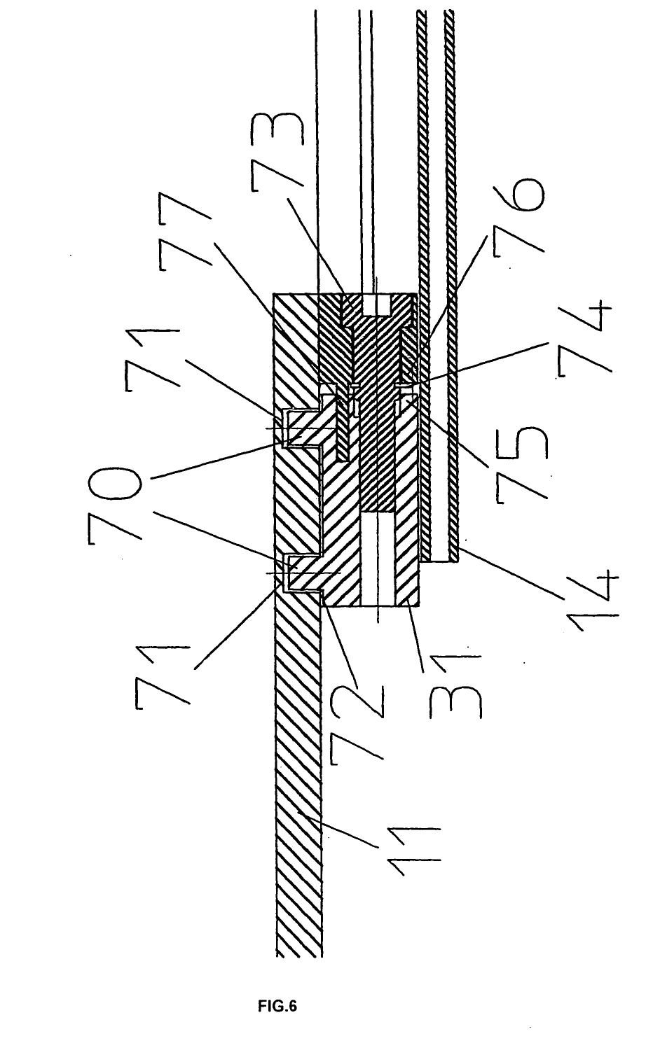

FIG. 6 a sectional view through the sliding door and a door-side element connected to it.

FIGS. 1a and 1b show a partition 10 with sliding doors 11 made of curved panels, in particular glass panels and partition elements 12 made of flat panels. The sliding doors 11 can be moved by means of slides or carriages 13 along rails 14 and 15. In the closed state, at least one surface side of the sliding doors 11 closes flush with a surface side of the adjacent partition elements 12. To open the sliding door, it is displaced out of a first plane, which corresponds to the closed state of the sliding door 11 when a flush closure pertains with the surface side of the partition element 12, into a second plane (see FIGS. 1a, 1b, and 2). Once the sliding door 11 has been brought into the position of the second plane, it can be moved along the rails 14 and 15 in order to clear the opening 16 which is to be closed.

The slide or carriage 13 can be moved by means of rollers 30 (FIG. 3 a) in the rails 14. In order to guarantee reliable guidance of the rollers 30 in the rail 14, the rail 14 is designed as a U-profile, the limbs of which engage around the rollers 30.

As FIGS. 3a and 4 show, the slide 13 exhibits a rail-side element 31, to which the rollers 30 are secured, a door-side element 32 and a connection element 33. The connection element 33 connects the rail-side element 31 with the door-side element 32. The rail-side element 31 and the door-side element 32 are in each case connected by jointed points 34 in a jointed manner to the connection element 33. Accordingly, the sliding door 11 can be moved backwards and forwards out of the first plane, which corresponds to the closed state, into the second plane, which corresponds to the opened state. Once the sliding door I 1 has been positioned into the second plane, it can be moved along the rails 14 and 15. A spring 38, which engages in the rail-side element 31 and the connection element 33, presses the hinge into the opening position.

Magnets 35 fix the rail-side element 31 with the connection element 33 in the closed state (FIG. 4) against the force of the spring 38. In the closed state, the rail-side element 31, the door-side element 32, and the connection element 33, which in each case are designed as tabs, are located next to one another, so that, with the sliding door 11 in the closed state, the slide 13 requires only very little space. A wedge 36, fitted to the rail 14 in a fixed position, is located in an aperture 37 in the closed state (FIGS. 3b and 4).

If the sliding door 11 is moved along the rails 14 and 15 to be opened, the aperture 37 moves relative to the wedge 36 along their oblique contact surfaces, so that the connection element 33 is moved from the rail-side element 31, and, as a result, the attraction force of the two magnets 35 is overcome. This is supported by the pressure force of the spring 38. As a consequence, the sliding door 11 can then be very easily moved out of the first plane into the second plane.

The partition element 12 exhibits cut-outs or apertures 60, in order to prevent a collision between the connection element 33 of the slide 13 and the partition element 12 when the sliding door 11 is positioned into its second plane for closing (FIG. 5). These apertures 60 are closed with brush elements 61, which withdraw when the sliding door is moved.

The door-side element 32 is provided with bolts 70, which engage in corresponding apertures 71, located in the sliding door 11 (FIG. 6). The rail-side element 31 can then be connected to the sliding door 11 by means of an adhesive 72, which for preference takes the form of an adhesive film. By means of a setting screw 73, the sliding door 11 can be adjusted relative to the rail 14 in the axial direction of the screw 73. A locking ring 74, together with a stop 75 and 76, delimit the adjustment range of the setting screw 73. A guide element 77 ensures optimum guidance in the direction of the screw axis.

1-13. (canceled)

14. An assembly, comprising:
at least one sliding door (11)guided in rails (14, 15) by slides or carriages (13), wherein the slides or carriages (13) include a rail-side element (31) and a door-side element (32), said rail-side element and door-side element connected to one another by a connection element (33) attached to jointed points (34); and
at least one partition element (12) adjacent to said at least one sliding door,
whereby at least one surface side of at least one sliding door (11) in the closed state closes flush with at least one surface side of at least one partition element (12).

15. The assembly according to claim 1, wherein the rail-side element (31), the door-side element (32), and the connection element (33) are designed as tabs.

16. The assembly according to claim 1, wherein, when the sliding door (11) is closed, the rail-side element (31) and the door-side element (32) are each in contact with the opposite sides of the connection element (33).

17. The assembly according to claim 1, further including magnets fitted to the rail-side element (31) and the connection element (33) and/or the door-side element (32) and the connection element (33), said magnets disposed on top of one another when the door is closed.

18. The assembly according to claim 1, wherein, when the sliding door (11) is closed, the rail-side element (31) and the door-side element (32) of the slide or carriage (13) are subject to spring pre-tension in the open position.

19. The assembly according to claim 1, wherein the slides or carriages (13) further include running rollers (30).

20. The assembly according to claim 1, further including at least one wedge (36), disposed on at least one of the rails (14, 15),
wherein said at least one wedge (36), when the sliding door (11) is closed, engages a correspondingly-shaped cut-out or aperture (37) of the connection element (33).

21. The assembly according to claim 20, wherein the wedge (36) is adjustable along the length of the rails (14, 15).

22. The assembly according to claim 1, further including bolts (70), disposed at the door-side element (32), said bolts (70) engaging corresponding openings (71) in at least one sliding door (11).

23. The assembly according to claim 22, wherein the door-side element (32) is adhesively bonded to the minimum of one sliding door (11).

24. The assembly according to claim 1, further including a setting screw (73) is screwed into the door-side element (32), wherein said setting screw (73) adjusts the door-side element (32) with respect to the rail (14, 15).

25. The assembly according to claim 1, further including cut-outs or apertures (60) disposed in at least one partition element (12) adjacent to the at least one sliding door (11).

26. The assembly according to claim 1, wherein the at least one sliding door (11) and/or partition element (12) are curved.

27. The assembly according to claim 26, wherein the at least one sliding door (11) and/or partition element (12) include glass panels.
